(19) United States
(12) Patent Application Publication
(10) Pub. No.: US 2008/0077647 A1
(43) Pub. Date: Mar. 27, 2008

(54) Parameterized VLSI Architecture And Method For Binary Multipliers

(76) Inventors: Adly T. Fam, East Amherst, NY (US); Thomas Poonnen, Cortland, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/850,887

(22) Filed: Sep. 6, 2007

Related U.S. Application Data
(60) Provisional application No. 60/842,496, filed on Sep. 6, 2006.

(51) Int. Cl. G06F 7/487

(52) U.S. Cl. 708/625

(57) ABSTRACT

Systems and methods of multiplying binary numbers are disclosed. In one such system there is a Sigma unit and an Omega unit. The Sigma unit may generate partial sums of the multiplier and shifted forms of the multiplier. The Omega unit may have a plurality of control units, a plurality of switch units, and a multi-shifter-adder (“MSA”). In some embodiments of the invention, more than one Omega unit is provided.

### CROSS-REFERENCE TO RELATED APPLICATION

This application claims the benefit of priority to U.S. provisional patent application Ser. No. 60/842,496, filed on Sep. 6, 2006.

### FIELD OF THE INVENTION

The present invention relates to systems and methods for multiplying binary numbers using electronic circuits. The present invention may be used to create very large scale integration (“VLSI”) architectures for performing arithmetic operations in integrated circuits (“IC”), computer processors and field programmable gate arrays (“FPGA”), and in particular, binary multipliers that are used for performing binary multiplication.

### BACKGROUND OF THE INVENTION

Binary multiplication, or the multiplication of binary numbers, is a critical computational operation in most digital applications. It involves the computation of all partial products that are obtained by multiplying the multiplicand (first number) by each bit of the multiplier (second number), and appropriately combining (shifting and adding) such partial products to obtain the desired product. Consider the desired multiplication of an unsigned binary number X=xₘ₋₁ . . . x₁x₀ of width m with an unsigned binary number Y=yₙ₋₁ . . . y₁y₀ of width n, where xᵢ, yⱼε{0, 1} for i=0, 1, . . . , (m−1) and j=0, 1, . . . , (n−1). Let Z denote the product of X and Y. In this particular case, X is the multiplicand and Y is the multiplier. Z is now computed as
Z=X×Y=X×(2ⁿ⁻¹yₙ₋₁+ . . . +2¹y₁+2⁰y₀)=2ⁿ⁻¹(X×yₙ₋₁)+ . . . +2¹(X×y₁)+2⁰(X×y₀) Equation (1)

Using two's complement representation for signed binary numbers, the method described in Equation 1 above can also be applied for multiplying signed binary numbers. In this case, the signed product will also be in two's complement form, which is favorable for further signed operations.

However, as the width of the multiplicand and/or the multiplier increases, there is a corresponding increase in the width and/or the number of required partial products, making the method described in paragraph 0003 unsuitable for implementing binary multipliers in arithmetic intensive applications such as signal processing, scientific computations and cryptography.

Due to this reason, considerable attention has been given to computationally efficient binary multiplier architectures that are based on partial product reduction algorithms. For example, see U.S. Pat. No. 5,691,930, U.S. Pat. No. 4,745,570 and U.S. Pat. Appl. No. 20040230631. But as the complexities of such partial product reduction algorithms [see Ref. 1; Ref. 2] increase, so does the irregularity of the architectures based on them, causing such architectures to be less efficient for VLSI implementation.

Divide and conquer algorithms operate by reducing a large problem into a number of smaller problems that are easy to solve. A parameterized divide and conquer algorithm for simultaneous computation of partial sums is described in Ref. 3. That algorithm optimally partitions the desired computation into parts that assume a relatively small number of distinct forms. The redundancy resulting in the repetition of a given form is removed by computing each form only once. The algorithm has been shown to replace D additions required in the direct computation of simultaneous partial sums by O(D/log₂ D).

A multi-signal bus architecture (“MSBA”) for finite impulse response (“FIR”) filters based on this algorithm has been demonstrated to achieve significant area savings in comparison to the direct form realization. See Ref. 4 and Ref. 5.

The present invention may be embodied as a VLSI architecture for binary multipliers that is based on the parameterized divide and conquer algorithm introduced in Ref. 3. The architecture consists of two types of basic units, a first type of unit that optimally partitions the computation involved in the multiplication of binary numbers into a set of all possible distinct partial sums and a second type of unit that appropriately combines such partial sums to obtain the desired product. The architecture is parameterized by a partition parameter that is optimized to minimize a desired computational complexity measure such as area or area-time product.

### SUMMARY OF THE INVENTION

The invention may be embodied as a system for multiplying a binary multiplicand and a binary multiplier to produce a product. Such a system may have a Sigma unit and an Omega unit. In one such system, the Sigma unit generates partial sums of the multiplier and shifted forms of the multiplier. The partial sums are sometimes collectively referred to herein as “p-sums”. The Sigma unit may have a plurality of outputs, each such output being capable of providing one of the p-sums. The Sigma unit may include a plurality of adders.

The Omega unit may have a plurality of control units, a plurality of switch units, and a multi-shifter-adder (“MSA”). Each control unit may have an input related to the multiplicand, and each control unit may have a plurality of outputs connected to a set of the switch units, and each output may be connected to a different one of the switch units in the set. The input related to the multiplicand may be a partition of the multiplicand.

Each switch unit may have a first input, a second input and an output. The first input may be connected to one of the control unit outputs, and the second input may be connected to one of the outputs of the Sigma unit. At least some of the switch units may be configured to provide either one of the p-sums from the Sigma unit or a zero, depending on a signal from the control unit.

The MSA may have a plurality of inputs and an output. Each MSA input may be connected to one of the sets of switch units operated by a particular control unit, and each MSA input may be able to receive one of the p-sums from the Sigma unit or a zero via the switch unit that is selected by the control unit. The output of the MSA may provide the product of the multiplicand and the multiplier. The MSA may have circuitry for performing shift-add operations for combining the p-sums selected by the control units.

In some embodiments of the invention, more than one Omega unit is provided.

The invention may be embodied as a method of multiplying a multiplicand and a multiplier. In one such method, a partition parameter (“r”) is chosen. The multiplicand may be partitioned into a number (“s”) of partitions, where s is an integer number equal to the number (“m”) of binary digits comprising the multiplicand divided by r. Then 2^{r}−1 distinct partial sums of the multiplier and r−1 shifted forms of the multiplier may be generated. The partial sums are sometimes collectively referred to as the “p-sums”. One of the partitions of the multiplicand may be provided to a control unit, and a control substring may be generated. The control substring may correspond to the provided one of the partitions, and the control substring may have 2^{r} bits. The control substring may be used to select one of the p-sums or a zero, and the selected one of the p-sums or zero may be provided to a multi-shifter-adder. This process may be repeated until all partitions of the multiplicand have been used to provide p-sums or a zero to the MSA. The MSA may be used to combine the provided p-sums to produce a product of the multiplicand and the multiplier. Combining the p-sums may be accomplished by using shift-add operations.

### BRIEF DESCRIPTION OF THE DRAWINGS

For a fuller understanding of the nature and objects of the invention, reference should be made to the accompanying drawings and the subsequent description. Briefly, the drawings are:

FIG. 1 illustrates an embodiment of the invention having a Sigma unit 10 and an Omega unit 20;

FIG. 2 illustrates a Sigma unit 10 for r=3;

FIG. 3 illustrates a PSM 30;

FIG. 4 illustrates a C unit 302;

FIG. 5 illustrates a Control unit 304 for r=3;

FIG. 6 illustrates an MSA 40;

FIG. 7 shows Table 1; and

FIG. 8 illustrates an alternate embodiment of the invention having a Sigma unit 10 and a plurality of Omega units 20;

### FURTHER DESCRIPTION OF THE INVENTION

The invention may be implemented as a device and/or a method of multiplying a binary multiplicand with a binary multiplier. An embodiment of the invention is a VLSI architecture referred to herein as the Parameterized Binary Multiplier Architecture (“PBMA”). It is based on an existing parameterized divide and conquer algorithm that uses optimal partitioning and redundancy removal for simultaneous computation of partial sums. The PBMA may be implemented to have two types of basic units. The first type of basic unit is referred to herein as the Sigma unit 10, and the second type of basic unit is referred to herein as the Omega unit 20. The Sigma unit 10 may generate distinct partial sums of the multiplier and shifted forms of the multiplier. The partial sums are referred to collectively as “p-sums”.

The Omega unit 20 may combine the partial sums generated by the Sigma unit 10 in order to obtain the product of the multiplicand and the multiplier. The architecture is parameterized by a partition parameter, that is referred to herein as “r”. The partition parameter may be selected so as to minimize a desired computational complexity measure such as area or area-time product.

A central principle of operation for the PBMA is adapted from Ref. 3 and is described below. For reference purposes, “m” is the number of binary digits in the multiplicand (“X”), and “n” is the number of binary digits in the multiplier (“Y”). Since multiplication is commutative, in the multiplication X×Y we can assume that m≧n without imposing any limitation.

In order to implement the invention, initially X is partitioned into a number (“s”) of partitions, where s=┌m/r┐. The partitions may be thought of as short multiplicands of width r. As such, X may be written as:
X=[2^{s×r-r} . . . 2^{r}2⁰]*P*[2^{r-1} . . . 2¹2⁰]^{T} Equation (2)
where * indicates matrix multiplication, T denotes the transpose of a matrix and

$$P = [ \begin{matrix}{x}_{s ⨯ r - 1} & … & {x}_{s ⨯ r - r} \\ … & … & … \\ {x}_{2 r - 1} & … & {x}_{r} \\ {x}_{r - 1} & … & {x}_{0}\end{matrix} ] \qquad Equation ( 3 )$$

Since xᵢε{0, 1}, the s×r matrix P can have at most 2^{r}−1 distinct rows that have at least one non-zero element. Any redundancy due to the repetition of one or more rows in P may be eliminated by expressing P as P_{X}*P₁, where P_{X} is a s×(2^{r}−1) matrix with at most one ‘1’ in each row and ‘0’s elsewhere, and P₁ is a (2^{r}−1)×r matrix with its I^{th} row containing the binary digits of integer I as its entries, resulting in:
X=[2^{s×r-r} . . . 2^{r}2⁰]*P_{X}*P₁*[2^{r-1} . . . 2¹2⁰]^{T} Equation (4)
where P₁*[2^{r-1} . . . 2¹2⁰]^{T} generates a column of all possible 2^{r}−1 polynomials of degree r−1 in powers of 2, while [2^{s×r-r} . . . 2^{r}0]*P_{X} assigns to each such polynomial all terms in Equation (2) that share it.

Now, the product (“Z”) of the multiplicand and multiplier, Z=X×Y, may be expressed as:
Z=[2^{s×r-r} . . . 2^{r}2⁰]*P_{X}*P₁*[2^{r-1} . . . 2₁2⁰]^{T}×Y Equation (5)

The PBMA may be thought of as an implementation of Equation (5). The partition size is parameterized by the partition parameter r, which may be selected to minimize a desired computational complexity measure, such as area or area-time product. The Sigma unit 10 of the PBMA may be embodied to implement P₁*[2^{r-1} . . . 2¹2⁰]^{T}, and the Omega unit 20 may be embodied to implement [2^{s×r} . . . 2^{r}2⁰]*P_{X}.

The Sigma unit 10 may generate 2^{r}−1 distinct partial sums of the multiplier Y and shifted forms of the multiplier 2Y, . . . , 2^{r-1}Y. The partial sums are sometimes referred to herein as Y, 2Y, . . . , (2^{r}−1)Y.

The Omega 20 unit may be thought of as implementing the equation [2^{s×r-r} . . . 2^{r}2⁰]*P_{X}. The Omega unit 20 may include two types of sub-units. A first such type of sub-unit sends either one of the partial sums or a ‘0’ to appropriate nodes of a second such type of sub-unit. The second type of sub-unit then combines the outputs from the first sub-unit to obtain the desired product.

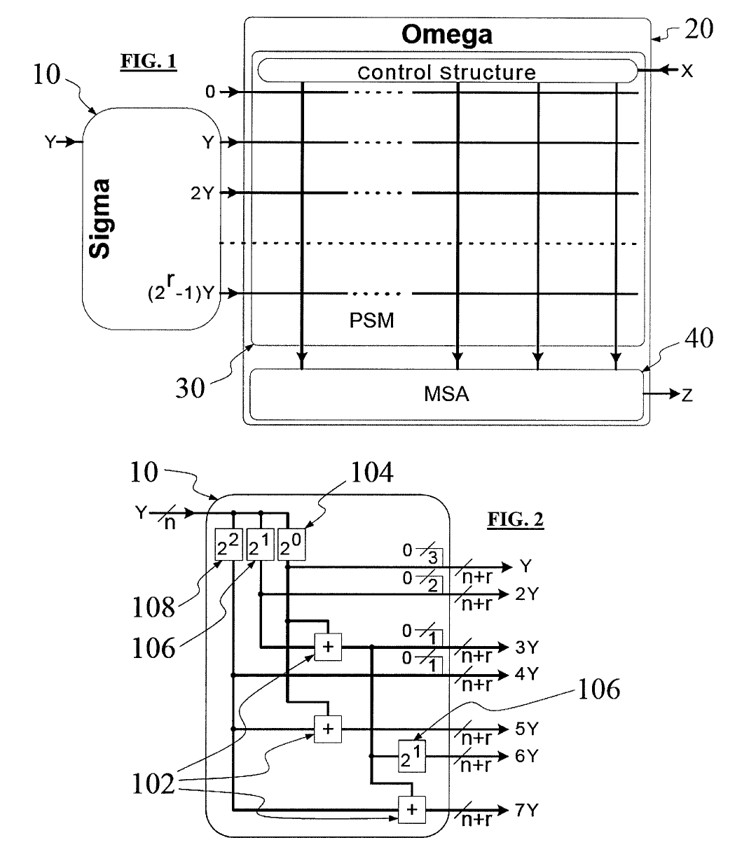

An embodiment of the invention is depicted in FIG. 1. In FIG. 1, the Sigma unit 10 is efficiently realized using only 2^{r-1}−1, n-bit adder units 102. FIG. 2 depicts one such Sigma unit for the situation in which r has been selected to equal 3. Depending on the application, the n-bit adder units 102 in the Sigma unit 10 may be implemented using basic adder architectures like the Ripple-Carry Adder (“RCA”) for minimal silicon utilization or using faster adder architectures like the Carry-Look-Ahead Adder (“CLA”) for higher operational speed. Units of type 2′ that represent a t-bit shift operation, such as 2⁰ 104, 2¹ 106 and 2² 108 are used only for functional clarity and it will be recognized that they may be realized by appropriately hardwiring the involved signals.

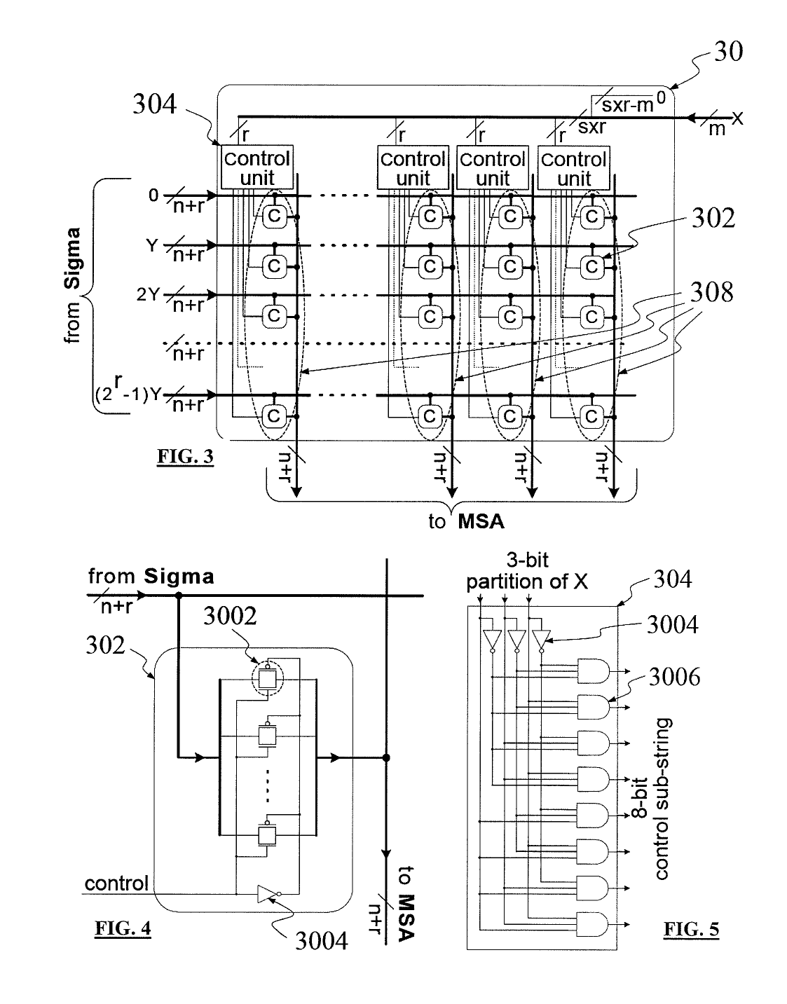

The first type of sub-unit of the Omega unit 20 that performs the sending task may be implemented using a programmable switch matrix (“PSM”) 30. The PSM 30 may be based on the crossbar topology commonly employed in smaller asynchronous transfer mode (“ATM”) networks and field programmable gate arrays (“FPGA”). The PSM may be strictly nonblocking and capable of multicasting. The PSM 30 shown in FIG. 3 is a programmable array of s×2^{r} identical switch elements called C units 302. The C units that are connected to the same input of the MSA are referred to herein as a set 308 of C units. FIG. 4 shows a C unit 302 that employs n+r complementary pass transistor switches 3002 and an inverter 3004.

By careful inspection, it can be observed that one switch per 2^{r} switches will pass or not pass only the ‘0’, thereby requiring only an NMOS transistor. Therefore, the PSM 30 could be implemented using s×(2^{r}−1) complementary switch elements of type C used to broadcast the partial sums, and s NMOS-only switch elements of an alternate type C′, used to broadcast the ‘0’. However, in a currently preferred embodiment of the present invention, the PSM 30 is realized using only identical C units 302 to maintain the overall modularity of the architecture. Further, since the PSM 30 may be implemented to require only s+2^{r} buses of width n+r, it also compares favorably in metallization area to a multiplexer based selection structure that would require s×2^{r}+2^{r} buses of the same width.

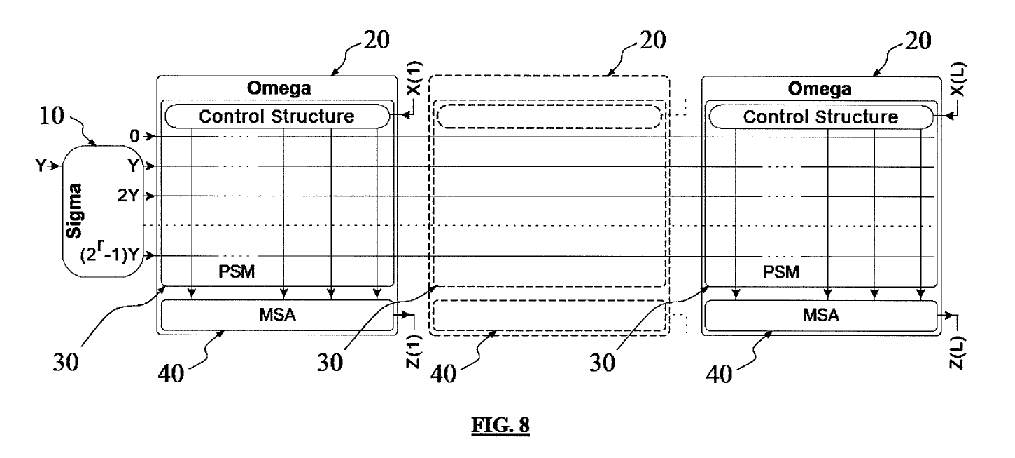

A control algorithm is required to configure the PSM 30. In a currently preferred embodiment of the invention, the s×2^{r} control bits, which are required to turn on or off the appropriate C units 302, are generated from the available m bits of X. One such means of creating the control bits extends X to s×r bits by adding s×r−m ‘0’s to the most significant part of X. Then X is partitioned into s, r-bit partitions, and each such partition is decoded into a 2^{r}-bit control sub-string. FIG. 7 depicts Table 1, which illustrates the control sub-strings that may be used when r=3.

In a currently preferred embodiment of the invention, the algorithm described in the paragraph 0028 may be realized using s control units 304. Each control unit 304 may be functionally identical to a binary decoder and may include r inverters 3004, and 2^{r}, r-input AND gates 3006. FIG. 5 depicts such a control unit 304 for r=3.

An embodiment of the second type of sub-unit of the Omega unit, 20, which computes the final product, is referred to herein as the multi-shifter-adder (“MSA”) 40. Its operation may be similar to the shift-add operation of a conventional multiplier, except that there are r shifts, instead of one, between any two additions. This functional similarity facilitates implementation of the MSA by allowing the MSA to be based on several existing multiplier architectures, with minor modifications.

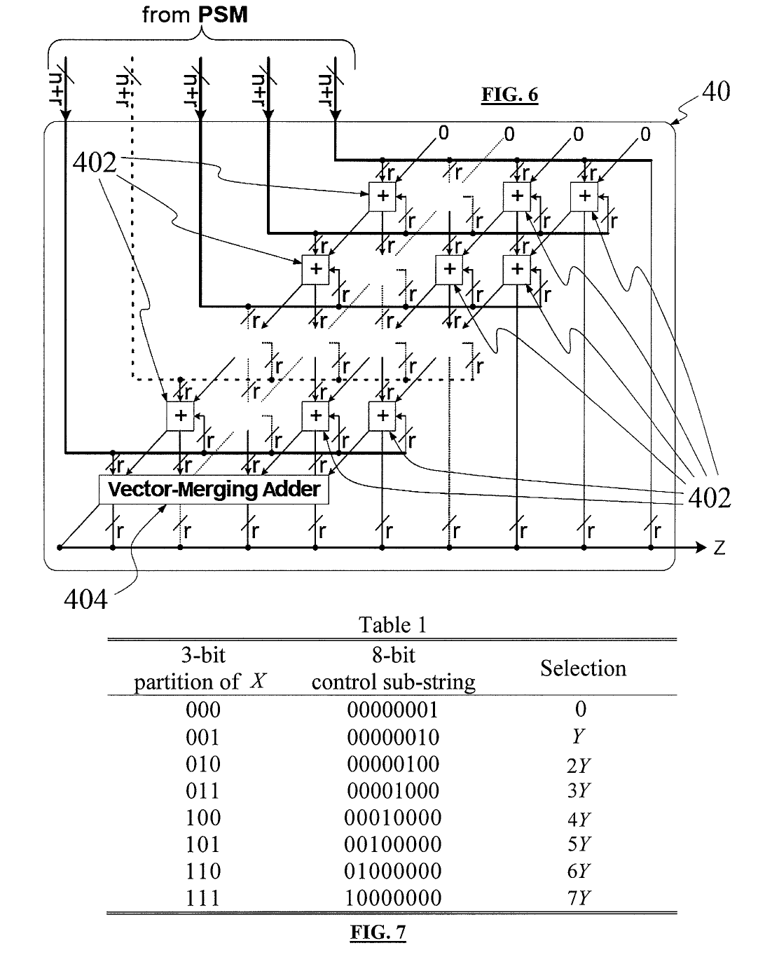

In a currently preferred embodiment of the present invention, the MSA 40 is based on the Carry-Save Array Multiplier architecture, and is realized using s×(s−1), r-bit adder units 402, and a final vector-merging adder 404. FIG. 6 depicts one such arrangement. Depending on the application, the r-bit adder units 402, and the final vector-merging adder 404 may be implemented using basic adder architectures like the Ripple-Carry Adder (RCA) for minimal silicon utilization or using faster adder architectures like the Carry-Look-Ahead Adder (CLA) for higher operational speed.

An extension of the PBMA for simultaneously performing binary multiplication of a number (“L”) of multiplicands, X(1)=×(1)ₘ₋₁ . . . ×(1)₁×(1)₀, X(2)=×(2)ₘ₋₁ . . . ×(2)₁ . . . ×(2)₀, . . . , X(L)=×(L)ₘ₋₁ . . . ×(L)₁×(L)₀, by a given multiplier, Y=yₙ₋₁ . . . y₁y₀, includes a Sigma unit 10 and L Omega units 20. FIG. 8 depicts one such system. The resulting L products are Z(1)=X(1)×Y, . . . , Z(L)=X(L)×Y. The Sigma unit 10 may generate the 2^{r}−1 distinct partial sums of Y, 2Y, . . . , 2^{r-1}Y. The resulting 2^{r}−1 distinct partial sums are Y, 2Y, . . . , (2^{r}−1)Y. The implementation of the Sigma unit 10 and each of the Omega units 20 in a currently preferred embodiment of the invention are described above.

For high-speed applications, the Sigma unit 10 and the MSA 40 may be based on faster tree architectures, such as the Wallace Multiplier [Ref. 6] or the Dadda Multiplier [Ref. 7].

For high throughput operation, a pipelined implementation [Ref. 8] of the PBMA is suggested. A reduced version of the PBMA that generates a truncated or rounded product [Ref. 9] could also be desirable in certain signal processing applications.

Although the invention has been described with reference to specific embodiments, the invention is not limited to these embodiments. Rather, other embodiments of the invention may be made without departing from the spirit and scope of the invention. For example, references Ref. 10, Ref. 11, and Ref. 12 describe other embodiments of the invention. Hence, the present invention is deemed limited only by the appended claims and the reasonable interpretation thereof.

The following references are cited in the foregoing text:
[Ref. 1] A. D. Booth, A signed binary multiplication technique, Quarterly Journal of Mechanics and Applied Mathematics 4, 1961, pp. 236-240.
[Ref. 2] C. R. Baugh and B. A. Wooley, A two's complement parallel array multiplication algorithm, IEEE Transactions on Computers 22(12), 1973, pp. 1045-1047.
[Ref. 3] A. T. Fam, Optimal partitioning and redundancy removal in computing partial sums, IEEE Transactions on Computers 36(10), 1987, pp. 1137-1143.
[Ref. 4] A. T. Fam, A multi-signal bus architecture for FIR Filters with single bit coefficients, Proceedings of IEEE International Conference on Acoustics, Speech, and Signal Processing (ICASSP), 1984, pp. 111.11-11.11.3.
[Ref. 5] T. Poonnen and A. T. Fam, An area-efficient VLSI implementation for programmable FIR Filters based on a parameterized divide and conquer approach, Proceedings of IEEE International Conference on Microelectronics (ICM), 2003, pp. 93-96.
[Ref. 6] C. S. Wallace, A suggestion for a fast multiplier, IEEE Transactions on Electronic Computers 13, 1964, pp. 14-17.
[Ref. 7] L. Dadda, Some schemes for parallel multipliers, Alta Frequenza 34, 1965, pp. 349-356.
[Ref. 8] J. R. Jump, S. R. Ahuja (1978), Effective Pipelining of Digital Systems, IEEE Transactions on Computers, 27(9), 1978, pp. 855-865.
[Ref. 9] E. E. Swartzlander Jr., Truncated multiplication with approximate rounding, Record of IEEE Asilomar Conference on Signals, Systems, and Computers (ACSSC), 1999, pp. 1480-1483.
[Ref. 10] T. Poonnen, A. T. Fam, A Novel VLSI Divide and Conquer Implementation of the Iterative Array Multiplier, Proceedings of IEEE International Conference on Information Technology—New Generations (ITNG), 2007, pp. 723-728.
[Ref. 11] T. Poonnen, A. T. Fam, A Novel VLSI Divide and Conquer Array Architecture for Vector-Scalar Multiplication, Proceedings of IEEE International Conference on IC Design and Technology (ICICDT), 2007, pp. 41-44.
[Ref. 12] T. Poonnen, Efficient VLSI Divide and Conquer Array Architectures for Multiplication, Ph.D. dissertation, State University of New York at Buffalo, N.Y., 2007.

What is claimed is:

1. A binary multiplication system for multiplying a multiplicand and a multiplier to produce a product, comprising:
a Sigma unit, which generates partial sums of the multiplier and shifted forms of the multiplier (the partial sums being referred to as the “p-sums”), and has a plurality of outputs, each Sigma unit output providing one of the p-sums;
an Omega unit having a plurality of control units, a plurality of switch units, and a multi-shifter-adder (“MSA”), wherein;
each control unit has an input related to the multiplicand, and each control unit has a plurality of outputs connected to a set of the switch units, and each output is connected to a different one of the switch units in the set;
each switch unit has a first input, a second input and an output, the first input being connected to one of the control unit outputs, and the second input being connected to one of the outputs of the Sigma unit or a zero;
the MSA has a plurality of inputs and an output, wherein:
each MSA input is connected to one of the sets of switch units operated by a particular control unit, and each MSA input is able to receive one of the p-sums from the Sigma unit or a zero via the switch unit selected by the control unit; and
the output of the MSA providing the product of the multiplicand and the multiplier.

2. The system of claim 1, wherein the Sigma unit includes a plurality of adders.

3. The system of claim 1, wherein at least some of the switch units are configured to provide either one of the p-sums from the Sigma unit or a zero, depending on a signal from the control unit.

4. The system of claim 3, wherein at least some of the switch units are configured to provide one of the p-sums from the Sigma unit if the control unit provides a binary one.

5. The system of claim 3, wherein at least some of the switch units include a first type of switch element that is capable of sending one of the p-sums, and a second type of switch element that is capable of sending a zero.

6. The system of claim 3, wherein at least some of the switch units include multiplexing units.

7. The system of claim 3, wherein at least some of the switch units include nonblocking multicasting network structures.

8. The system of claim 1, wherein the input related to the multiplicand is a partition of the multiplicand.

9. The system of claim 1, wherein the MSA has circuitry for performing shift-add operations for combining the p-sums selected by the control units.

10. A binary multiplication system for multiplying a multiplicand and a multiplier to produce a product, comprising:
a Sigma unit, which generates partial sums of the multiplier and shifted forms of the multiplier (the partial sums being referred to as the “p-sums”), and has a plurality of outputs, each Sigma unit output providing one of the p-sums;
an Omega unit having a programmable switch matrix (“PSM”) and a multi-shifter-adder (“MSA”), wherein:
the PSM has a first set of inputs for receiving information corresponding to the multiplicand, a second set of inputs, and a set of outputs, wherein each input in the PSM's second set of inputs is connected to a different one of the outputs of the Sigma unit so that one of the p-sums from the Sigma unit or a zero can be provided at the outputs of the PSM based on the first set of inputs, and
the MSA has a plurality of inputs, each MSA input being connected to a different one of the PSM's outputs, wherein the MSA includes circuitry for combining the p-sums to produce the product of the multiplicand and the multiplier.

11. The system of claim 10, wherein the Sigma unit includes a plurality of adders.

12. The system of claim 10, wherein the PSM is able to provide either one of the p-sums from the Sigma unit or a zero to the MSA, depending on information received at the first set of inputs.

13. The system of claim 12, wherein the information received at the first set of inputs is a partition of the multiplicand, and the PSM includes a control unit that accepts the partition of the multiplicand and correlates the accepted partition with a control signal, the control signal being provided to a plurality of switch elements of the PSM.

14. The system of claim 13, wherein the switch elements are arranged to provide one of the p-sums from the Sigma unit when the control signal provides a binary one to the switch element.

15. The system of claim 10, wherein the PSM includes a first type of switch element capable of sending to the outputs of the PSM one of the p-sums from the Sigma unit, and a second type of switch element capable of sending to the outputs of the PSM a zero.

16. The system of claim 10, wherein the PSM includes multiplexing units.

17. The system of claim 10, wherein the PSM includes nonblocking multicasting network structures.

18. The system of claim 10, wherein the first set of inputs receive a partition of the multiplicand.

19. The system of claim 10, wherein the MSA circuitry is capable of combining the p-sums using shift-add operations.

20. A method of multiplying a binary multiplicand and a binary multiplier, comprising:
(a) choosing a partition parameter (“r”);
(b) partitioning the multiplicand into a number (“s”) of partitions, where s is an integer number equal to a number (“m”) of binary digits comprising the multiplicand divided by r;
(c) generating 2^{r}−1 distinct partial sums of the multiplier and r−1 shifted forms of the multiplier (the partial sums being referred to as the “p-sums”);
(d) providing one of the partitions of the multiplicand to a control unit;
(e) generating a control sub-string corresponding to the provided one of the partitions, the control sub-string having 2^{r} bits;
(f) using the control substring to select one of the p-sums or a zero;
(g) providing the selected one of the p-sums or zero to a multishift adder;
(h) repeating steps (d) through (g) until all partitions of the multiplicand have been used to provide p-sums or a zero to the multishift adder; and
(i) combining the provided p-sums to produce a product of the multiplier and the multiplicand.

21. The method of claim 20, further comprising extending the multiplicand by adding zeros to the most significant part of the multiplicand so that m divided by r is an integer.

22. The method of claim 20, wherein combining the provided p-sums using shift-add operations.
